(19) United States
(12) Patent Application Publication
(10) Pub. No.: US 2012/0269950 A1
(43) Pub. Date: Oct. 25, 2012

(54) Chemical changes associated with selenite

(76) Inventors: Mark Hooper, Fredericksburg, TX (US); Jose M. Rodriguez, Starkville, MS (US)

(21) Appl. No.: 13/506,463

(22) Filed: Apr. 20, 2012

Related U.S. Application Data
(60) Provisional application No. 61/517,567, filed on Apr. 21, 2011.

(51) Int. Cl. A23L 1/30; A23L 2/38; C12G 3/00; C12G 1/00; A23F 3/00; A23F 5/00; A23C 9/00; A23G 1/56; C02F 1/68; A23L 2/02

(52) U.S. Cl. 426/592; 210/749; 426/648; 426/590; 426/599; 426/597; 426/594; 426/580; 426/593

(57) ABSTRACT

The present invention provides improved products and methods for treating liquids and beverages with selenite, resulting in measurable and favorable chemical changes. Beverages include water, fermented and distilled alcoholic beverages such as wine, beer, spirits and liquors and non-alcoholic beverages such as coffee, tea, soft drinks, fruit juices, ciders, herbal teas and dairy drinks. Also provided are selenite products and methods for beneficial treatment of living organisms (which are mostly liquid), including people; animals and plants. Additional products and methods are provided for treating and improving foods derived from animals and plants.

### BACKGROUND OF THE INVENTION

1. Field of the Invention

The present invention relates to selenite and its effect on liquids, semi-liquid compositions and compositions containing liquid. More particularly, the invention relates to chemical changes caused by selenite in liquids containing water or alcohol and compositions containing a liquid or moisture, including foods and living organisms.

2. Description of Related Art

Calcium sulfate (CaSO₄) is most commonly found as gypsum, CaSO₄-2(H₂O), hydrated calcium sulfate. The hemihydrate, CaSO₄-0.5(H₂O), is known as plaster of Paris. The anhydrous form occurs naturally as β-anhydrite. Gypsum is one of the more common evaporative minerals in sedimentary environments and the most common of the sulfates, occurring in massive beds, including the alabaster variety, typically from precipitation out of highly saline waters.

Gypsum is also found in varieties showing obvious crystalline structure, including clear crystals, the selenite variety; parallel fibrous crystal habits, the satin spar variety; and both “desert rose” and “gypsum flower” varieties. Crystalline forms can often be found in caves, evaporated lakes or seas, alkaline lake muds, clay beds, salt flats and salt springs. Though sometimes grouped together as “selenite,” the crystalline varieties have distinct characteristics.

Selenite is commonly found as tabular, columnar, reticular and/or acicular slightly flexible crystals. The crystals may appear to be water- or glass-like due to the lack of imperfections or inclusions, or may have a lustrous pearly appearance. Selenite typically feels silky and warm to the touch due to good insulation and poor heat conduction properties. Translucency and color is typically caused by the presence of other minerals and opacity can result from impurities, inclusions, druse and crust. Selenite crystals are found both attached to a matrix or base rock and as entire free-floating crystals. Selenite is sectile (easily cut with a knife), will peel (particularly selenite crystals that exhibit mica-like habit) and can be scratched by a fingernail (2 on the Mohs Scale of mineral hardness). Selenite crystals sometimes exhibit bladed rosette habit, usually transparent and like desert roses. Selenite crystals also sometimes form or can be formed into thin tabular or mica-like sheets and have been used as glass panes, including use in medieval times for windows and coverings of pictures of the Madonna (German marienglas or Mary's Glass). Selenite crystals may also exhibit chatoyancy (cat's eye reflections), double refraction, fiber optic qualities and fluorescence or phosphorescence.

Selenite crystals can range in size from minute to giant, with notable occurrences being found in Mexico, the United States including New Mexico, Utah and Colorado, Australia, and Europe including Greece and Spain. The largest individual selenite crystals, up to 15 meters (50 feet) long and weighing up to 45 metric tons, have been found in Mexico's Cueva de los Crystales, also known as the Cave of the Crystal Giants, in the Naica Mountain in Chihuahua.

The word “selenite” is derived from the Middle English selinete, from the Latin selenites, from the Greek selenites, meaning “moon stone” or “moon rock,” with the root word “selene” meaning “moon,” probably from the pearly luster which can glow and can resemble the moon. Selene is also the name of the Greek Goddess of the Moon, also known as Artemis or Luna or the Roman Diana. Selenite has referred to the variety of gypsum that occurs in transparent crystals since the 15th century.

Various metaphysical properties have been ascribed to selenite, including good fortune, the stimulation and strengthening of the neurological structures connecting the heart and the brain, various special abilities to synergistically combine with and alter the nature of physical matter, clearing of negativity and energy fields, allowing access to the interior of the physical body to understand existing disorders, and providing mental and emotional benefits. Health benefits have been reported including extension of life span, general heart, skeletal, teeth, skin and neurological benefits, moderation of hyperactivity and seizures and improvement of libido and fertility. Selenite is also reported to be useful for meditation and achieving mental clarity as well as purposes such as scrying.

It is thought that selenite may favorably affect physical and mental health and may favorably aid a course of treatment for all known infections, chronic, degenerative, neurological, episodic, bacterial, viral, cancerous and genetic diseases.

Selenite has also found use in attracting moisture, rainmaking and weather modification, including modern-day practices. The Pueblo Indians believed selenite was a rain maker/attractor, and the Hopi believe it is the tears of the Gods.

### SUMMARY OF THE INVENTION

The present invention provides products and methods utilizing selenite to treat and improve the chemical characteristics of liquids, beverages and foods (foods derived from both plants and animals typically contain liquid or moisture). Also provided are methods of using selenite products, including fabrics impregnated with selenite and materials containing selenite, to provide benefits to living organisms, including people, animals and plants (living organisms are typically mostly liquid).

The improved beverages of the present invention show unexpected properties including improved taste, odor, body, character, consistency and reduced bitterness, acidity and tannins after contact with selenite compositions. Beverages which may be improved via selenite treatment include fermented and distilled alcoholic beverages, wine, beer, spirits and liquors and non-alcoholic beverages such as water, soft drinks, ciders and fruit juices, coffee, tea and herbal teas, dairy drinks and chocolate drinks.

It is an object of the present invention to change the chemical characteristics of liquids by placing selenite on, under, around or adjacent to the means for using, storing and transporting liquids. Such means include drinking vessels and containers, pipes, hoses, tubes, channels and conduits used for liquids and beverages.

It is another object of the present invention to provide selenite coasters, countertops, trays, plates and bowls for food and beverages wherein the selenite changes the composition and chemical characteristics of any liquid present in the food or beverages.

It is another object of the invention to provide selenite products for treatment and support of liquids, foods and liquid-containing organisms as well as treatment of spaces, containers and vehicles for transporting, storing, conducting, serving and/or habitation by liquids, foods, or liquid-containing organisms.

It is another object of the invention to provide selenite processes for providing improved beverages.

It is another object of the invention to provide selenite products, processes and methods for positively changing the chemical characteristics of the subject and/or subject area.

The disclosed selenite products and processes herein have been found to achieve these objects and advantages. Other objects and advantages of this invention will become apparent from the following description and appended claims.

### DETAILED DESCRIPTION OF THE INVENTION

Before explaining the preferred embodiments of the present invention in detail, it is to be understood that the invention is not limited in its application to the particular details disclosed. No limitation with respect to the specific embodiments disclosed is intended or should be inferred. Although the present invention has been described with reference to preferred embodiments, numerous modifications and variations will be apparent to one skilled in the art. These modifications can be made and still the result will come within the scope of the invention. The terminology used herein is for the purpose of description and not of limitation.

In attempting to address the known problems present in the prior art, the present inventor has discovered that selenite slabs, coasters, trays, plates, bowls and other selenite products produce novel and unexpected changes in the properties of liquids including beverages, foods and living organisms. Liquids include all aqueous and/or alcoholic liquid and/or semi-liquid compositions and all compositions containing water or alcohol as well as compositions with a high moisture content.

Selenite crystals were obtained from the CRYSTALLINE PHOENIX® deposit in New Mexico, a massive, solid vein of selenite crystal visible on the surface for over 100 yards, surrounded by a deposit of CRYSTALLINE PHOENIX® alabaster, white with thin grey bands. The deposit has been laid down in a complex array of interlocking, massive selenite crystals—the largest encountered to date is estimated to be in excess of 1,800 kilograms and the largest selenite crystal actually removed from the deposit weighs in excess of 680 kg. (1,500 pounds). Each selenite crystal is comprised of compressed laminations or sheets of crystal, with the laminations being so compressed in the purest crystals that they are undetectable. CRYSTALLINE PHOENIX® selenite weighs approximately 2,880 kilograms per cubic meter (180 pounds per cubic foot). Mining was conducted in accord with all applicable State and Federal permit requirements, as well as ancient and modern metaphysical practices.

Selenite useful in the present invention may be in the form of slabs or natural crystals, shards, powder, dust and flakes, and may be cut and/or polished. Preferred selenite forms and compositions of the present invention include slabs, wine and beverage coasters, trays and serving trays, food platters, plates and bowls (for fruit and other foods), hot pads (selenite is an excellent insulator for protecting surfaces from hot pans and dishes), placemats, tiles, containers, countertops, tables, treatment tables, altars, table pillars, chairs, seats, foot rests, hand helds, benches, beds, mats, supports, platforms, tiles, paneling, flooring, foundations and flagstones. Selenite may also be used on, under, around or adjacent to pipes, hoses, tubing, channels, conduits and other means of liquid transport. Also preferred are methods of placing selenite in a liquid, including liquids in which it may partially or wholly dissolve such as water. Preferred embodiments include cloths and fabrics impregnated with selenite solution, for example, bedding, pillows, clothing, saddle blankets, carpets, drapes, tapestries, wall-hangings and cloth furniture. Other liquid-selenite applications include bath salts, bath powder and soaps and detergents. Selenite may also be used in materials such as concrete, cement, plaster, stucco, mortar, grout, paint and liquid polymers, coatings and resins. Selenite may be added to both water-based paints, where the selenite would typically be expected to be more soluble, and oil-based paints, lacquers and varnishes, where the selenite would typically be expected to be less soluble. Selenite powder has also been cleaned and sifted or screened and blown onto artistic paints after application to give a “stardust” effect. All such selenite compositions are useful for placing selenite in proximity to liquids or useful for supporting and/or surrounding all things liquid or containing liquids, including living organisms.

Preferred methods of forming selenite into shaped selenite compositions include wet tile saw, wet circular saw, wet chain saw, wet grinder, wet lapidary equipment and wet automotive emery cloth or polishing paper for polishing. Similar dry methods and other suitable methods known to those skilled in the art may also be utilized.

Various methods were utilized for analyzing the changes and improvements found in beverages subsequent to selenite treatment as described herein. The trained human nose and tongue is still the most trusted and reliable analytical method for fine beverages and scents, including such tastes as bitterness, sourness; saltiness, sweetness, unaminess, coolness, dryness, fattiness, heartiness, spiciness, aftertaste, etc.; the range of olfactory smells is much wider. Analytical testing, such as the Near Infrared Spectroscopy (“NIR”) referenced in Example 1 below can confirm changes, but human judgment and analysis is still the “gold standard” for beverages and foods, particularly gourmet and organic foods and beverages.

Blind taste testing of wine before and after sitting on selenite coasters was conducted and confirmed the changes in the beverages described herein. Test participants included a wine sommelier, a wine maker and an owner of wine companies, all of whom were initially skeptical about the potential for the selenite to affect wines. All surprisingly observed that the selenite coaster produced changes to the wine, with comments including “it reduced the tannin and the acidity,” “it smoothed out the taste,” and “it revealed more of the life force of the wine.” These tests confirming that selenite improves numerous beverage qualities in fine wines were conducted with selenite coasters approximately 9 cm.×9 cm.×2.5 cm. thick (3.5 in.×3.5 in.×1 in.).

Similar testing of selenite coasters with wine, water, tea, coffee, beer and juice have shown similar results and improvements. The most common comment is that it smoothes out the taste. Testers have also noted improved aroma, body, consistency, character, value, energy, response and essence of the beverages. Beer connoisseurs have commented that it reduced the bite, smoothed the taste, and mellowed that last few sips in the bottle that often are not all that great, especially if the beer has warmed.

All phases of beverage production, transportation, serving, presentation and consumption may theoretically benefit from selenite. In winemaking, selenite is laid out in the field of grapes in a grid or pattern (“gridding”) for planting and harvest, and selenite may be used in areas, buildings or rooms where processes including crushing, destemming, pulping, pressing, pigeage, fermentation, carbonation (for sparkling wines), stabilization, aging, blending, fining, filtration, bottling and and/or capping are carried out. Similarly, for the brewing of beer, fields of hops and barley may be gridded and the steeping, fermenting, malting, milling, mashing, lautering, boiling, whirlpooling, conditioning, fining, clarifying, filtering and/or packaging in cask, keg, bottle or can may be carried out in selenite surroundings or on selenite supports. The various alcohol distillery operations may also take place on selenite foundations, slabs, platforms or supports. Coffee plantations and roasting, storage, grinding, decaffeination, brewing, preparation, serving, consumption and enjoyment areas may be similarly carried out with selenite. Tea plants may be similarly grown and processed and tea leaves may be steeped, brewed and/or served or presented on selenite trays. An analogous approach may be taken with the production of roasted grain beverages, chocolate drinks, sodas, juices and other beverages.

The containers which may be placed on or near selenite include, for example, cups, glasses, bottles, decanters, kegs, casks, barrels, vats and equipment used in the production of beverages, including containers and equipment made of glass, crystal, ceramic, metal, wood or plastic. Pipes, hoses, tubing, channels and conduits which are used to transport liquids may also be placed on, around or adjacent to selenite compositions. In general, cups and containers made of glass are preferred for consumption of beverages; insulated plastic cups may block the effect of the selenite. Thickness of the coaster, tray or slab relates to the speed of the reaction, with thicker selenite products providing faster change or reaction.

In addition to beverage processes, the selenite products and methods of the present invention may also be utilized to improve all phases of food, herb, flower, agricultural and aquacultural production, and indeed all processes involving liquids or living organisms.

Starting from the perspective that selenite changes the chemical composition and chemical characteristics of liquids, foods and liquid-containing organisms, the following selenite compositions and associated processes have been found useful and also provide preferred examples:

1) For humans: selenite bath powder and bath solutions, body topicals with selenite powder, saturation or impregnation of clothing, sheets and bedding with selenite, selenite solutions in hot water bottles, selenite coasters, trays, plates, bowls, treatment tables, meditation seats, tables, foot pieces, room paneling, floors, shower stall enclosures, body pillows, body discs, hand-helds and pieces to be inserted under pillows, under beds, under chairs and under treatment tables and selenite room/house/workplace/property grids;

2) For animals: selenite grids, selenite bath solutions, under bed pieces, food/water coasters, blankets, bedding and pillows impregnated with selenite or containing selenite chips;

3) For property: selenite grids, pathways, landscaping, beacons and architectural applications;

4) For industry: selenite grids in and around offices/warehouses/buildings, slabs under liquid containers, water treatment, wine, beverage and food production, food preparation and serving counters and trays; and

5) For agriculture: selenite grids in and around ponds, fields, barns, processing areas and storage units, slabs under or around piping and containers of solutions used to grow plants, including water, fertilizer and hydroponic solutions.

Additional aqueous and/or alcoholic liquids which may be placed on or adjacent to selenite and improved by the present invention include medicinal or pharmaceutical preparations for external use such as extracts, tinctures and Aloe vera juice. Liquid preparations include solutions, saturated solutions, suspensions, emulsions, extracts, ointments, salves, creams, lotions, liquid soaps and skin and hair care products and solutions, including those liquids and treatments used in integrative medicine, alternative healing, holistic medicine, synergistic medicine, mind-body-spirit therapies and ancient and modern shamanistic practices in the healing tradition.

### Example 1

Near Infrared Spectroscopy (NIR) is used in the analysis of food, beverages, pharmaceuticals and fuels for the determination of fats, octane, fibers, antioxidants, alcohol, proteins, etc. This technique is based on combination vibration and molecular overtones of molecules. First and second overtone or combination absorption bands of only the C—H, O—H and N—H stretching vibrations are found in the near infrared region. NIR spectra are not easily interpreted due to small changes between different samples; however, they are very amenable to multivariate analysis. This technique is used after known component analysis has been performed.

### Experimental Methods

Two 250 ml square jars were cleaned for the experiments. Freshly brewed coffee was prepared. To each jar, we added approximately 10 ml of coffee. We continued to add coffee, alternating between jars, until each jar had 100 ml of coffee. This insures that both jars had representative samples of the coffee. The jars were sealed with their appropriate lid. One jar was place on top of a 5″×5″×1″ selenite square. The other was place on top of the bench approximately 1.2 meters (4 feet) away from the selenite. Each sample was probed by NIR from LT Inc. Transmission spectra were obtained for each sample. For each spectrum we obtained a first derivative to emphasize differences. We followed the above procedure for a dark beer and for a red cabernet sauvignon wine.

### Conclusions

Slight differences were observed between the selenite placed samples and non-selenite samples. This was observed in the 1300 to 1600 nanometers range of the near infrared. It should be emphasized that in the NIR range of the spectrum, small changes are significant. Chemometrics utilizes small changes in this spectrum ranges to determine fat, fiber and antioxidant content in food and octane values in fuels.

Comparative testing of Crystalline Phoenix® selenite coasters versus Moroccan selenite coasters gave comparable results.

### Example 2

Gridding: CRYSTALLINE PHOENIX® selenite was utilized in more than forty indoor and outdoor gridding and landscaping applications in Texas, Colorado, California, Montana, Oregon, Arizona, Iowa, New Mexico, British Columbia and Germany. The properties gridded ranged in size from a city lot to ranches of 50 and 75 acres, using from several hundred pounds to approximately 4,000 pounds of selenite and “gypsum coral,” including selenite crystal pieces from 4.5 kilograms (10 pounds) up to 45+ kilograms (100+ pounds). Amounts varied depending upon the requirements of the individual property. Selenite was placed in a monolith (pillar, beacon or obelisk), matrix, grid, or geometric pattern on, around, near, or in proximity to a shrimp farm, a wine vineyard, ranches, corporate offices, traditional and alternative medicine offices and spaces, college spaces, residences, homes, bedrooms, home offices, apartments, and domestic animal spaces and areas, as well as in foundations and walls during construction.

### Example 3

For architectural uses, selenite was inserted into the foundation corners and/or walls of structures during construction and selenite-containing concrete was utilized. Selenite crystals up to 725 kilograms (1,600 pounds) that allow significant light transmission may be used as an alternative to a window or light source in walls and ceiling. In a landscaping application, Crystalline Phoenix® selenite crystals have been found to add beauty and presence in addition to delivering the benefits of the claimed invention.

### Example 4

Anecdotal and clinical health benefit testimonials related to use of the selenite include healing of compressed discs, mitigation of lower back pain, reduction of pain medication, reduction in arthritic pain and stiffness, amelioration of migraines, soothing of heartburn, alleviation of sinus pressure and bronchitis, improvement of immune system, remedy for stress, alleviation of Autistic symptoms and hyperactivity, minimizing the effect of IBS and menstrual cramps, easement of joint pain and soothing/curing insect and spider bites.

Extensive testing was conducted with selenite on beverages, foods and living organisms. Further examples of the invention described above have been made and tested and found to deliver the advantages described. The selenite compositions, products, methods and processes thus offers new and novel properties as compared to those formulations known to the art. The need for the useful selenite products and processes of the present invention is made apparent by the list of applications and products.

It should be understood the foregoing detailed description is for purposes of illustration rather than limitation of the scope of protection accorded this invention, and therefore the description should be considered illustrative, not exhaustive. While the invention has been described in connection with preferred embodiments, it will be understood that there is no intention to limit the invention to those embodiments. On the contrary, it will be appreciated that those skilled in the art, upon attaining an understanding of the invention, may readily conceive of alterations to, modifications of, and equivalents to the preferred embodiments without departing from the principles of the invention, and it is intended to cover all these alternatives, modifications and equivalents. The scope of the patent protection is to be measured as broadly as the invention permits. Accordingly, the scope of the present invention should be assessed as that of the appended claims and any equivalents falling within the true spirit and scope of the invention.

We claim:

1. A method for treating and changing the chemical characteristics of liquids, foods and liquid-containing organisms comprising placing a subject selected from the group consisting of liquids, foods and liquid-containing organisms in proximity to a selenite composition.

2. The method of claim 1 wherein the liquid is a beverage in a container that is placed upon the selenite composition.

3. The method of claim 1 wherein the liquid is a beverage is selected from the group consisting of water, wine, beer, fermented alcoholic beverages, distilled alcoholic beverages, spirits, liquors, coffee, tea, soft drinks, ciders, juices, fruit juices, coffee, tea, herbal teas, dairy drinks and chocolate drinks.

4. The method of claim 1 wherein the selenite composition is selected from the group consisting of selenite slabs, blocks, chips, powder, crystals, coasters, sheets, trays, serving trays, food platters, plates, bowls, hot pads, placemats, tiles, containers, countertops, tables, treatment tables, altars, table pillars, chairs, seats, meditation seats, benches, beds, foot rests, foot pieces, mats, supports, tiles, paneling, flooring, shower stall enclosures, foundations and flagstones, body pillows, body discs, hand helds and pieces to be inserted under pillows, beds, chairs and treatment tables.

5. The method of claim 1 wherein the liquid is a component of a food.

6. The method of claim 1 wherein the liquid is water and the selenite composition is placed in the water and used to impregnate a fabric which is placed in proximity to a living organism.

7. The method of claim 6 wherein the fabric is selected from the group consisting of clothing, bedding, pillows, blankets, saddle blankets, carpets, drapes, tapestries, wall-hangings and furniture cloth.

8. The method of claim 1 wherein the selenite composition is selenite powder and the liquid is a water-containing liquid and the selenite powder is placed in the water-containing liquid to form a composition selected from the group consisting of selenite bath salts, bath powders, bath solutions, body topicals, soaps, detergents and solutions for hot water bottles.

9. The method of claim 1 wherein the selenite composition further comprises a composition selected from the group consisting of concrete, cement, plaster, stucco, mortar, grout, paint, liquid polymers, liquid coatings, liquid resins and combinations thereof.

10. The method of claim 1 wherein the selenite composition is used to grid a subject area in a manner selected from the group consisting of monolith, matrix, grid and geometric pattern grids.

11. The method of claim 1 wherein the selenite composition is utilized in the production of a composition selected from the group consisting of physical spaces, buildings, walls, floors, foundations, insulation, paint, coatings and combinations thereof.

12. The method of claim 1 wherein the selenite surrounds the liquid.

13. A method for improving the qualities of liquids and liquid-containing organisms within a subject area comprising gridding the subject area with selenite wherein the selenite is placed in proximity to the liquids and liquid-containing organisms.

14. The method of claim 13 wherein the subject area is selected from the group consisting of properties, buildings, residences, homes, houses, workplaces, offices, warehouses, restaurants, rooms, bedrooms, home offices, apartments, corporate offices, traditional and alternative medicine offices and spaces, college spaces, fields, gardens, farms, ranches, aquaculture farms, ponds, vineyards, domestic animal spaces and areas, produce processing areas, fields, barns and combinations thereof.

15. The method of claim 13 wherein the liquid-containing organisms are selected from the group consisting of people, animals and plants.

16. The method of claim 13 wherein the liquids comprise a food.

17. A method for changing and improving beverage taste, aroma and reducing beverage bitterness comprising placing a beverage in a container and placing the container in contact with a selenite composition prior to consumption.

18. The method of claim 17 wherein the beverage is selected from the group consisting of water, wine, beer, fermented alcoholic beverages, distilled alcoholic beverages, spirits, liquors, coffee, tea, soft drinks, ciders, juices, fruit juices, coffee, tea, herbal teas, dairy drinks and chocolate drinks.

19. The method of claim 17 wherein the container for the liquid is a means of liquid transport selected from the group consisting of pipes, hoses, tubing, channels and conduits and the liquid transport.

20. The method of claim 17 wherein the selenite composition is selected from the group consisting of selenite slabs, blocks, chips, powder, crystals, coasters, sheets, plates, trays, serving trays, food platters, plates, bowls, hot pads; placemats, tiles, containers, countertops, tables, altars, mats, supports and combinations thereof.
